(19) United States
(12) Patent Application Publication
(10) Pub. No.: US 2025/0100598 A1
(43) Pub. Date: Mar. 27, 2025

(54) TRACK MEASUREMENT REFERENCE POINT CREATION FROM LINEAR NETWORK RAILWAY TRACK MEASUREMENT DATA

(71) Applicant: Praedico, Amersfoort (NL)

(72) Inventors: Ali JAMSHIDI, Den Haag (NL); Yiwen Sun, Rotterdam (NL); Meylin Herrera Herrera, Amersfoort (NL); Marc de Wolf, Sleeuwijk (NL)

(21) Appl. No.: 18/898,199

(22) Filed: Sep. 26, 2024

Related U.S. Application Data
(60) Provisional application No. 63/585,937, filed on Sep. 27, 2023.

(51) Int. Cl. B61L 23/04; B61K 9/08; G01C 21/00

(52) U.S. Cl. CPC B61L 23/045; B61K 9/08; G01C 21/3807; G01C 21/3859

(57) ABSTRACT

A computing system may receive first and second linear network railway track measurement data collected during a first track measurement campaign and a second track measurement campaign. The first linear and second network railway track measurement data includes first and second data respectively corresponding to a shape and condition of a geographical segment of track. The computing system may geographically align the first and second linear network railway track measurement data collected during the first and second measurement campaigns using the first and second data corresponding to the shape and condition of the geographical segment of track collected in the first and second measurement campaigns to thereby generate first aligned data.

### CROSS-REFERENCE TO RELATED CASES

The present application claims priority from U.S. Provisional Patent Application Ser. No. 63/585,937, filed Sep. 27, 2023, the disclosure of which is hereby incorporated by reference herein in its entirety.

### BACKGROUND

Traditionally, railroad track maintenance and supervision relied on manual inspections. However, with the adoption of advanced scanning and monitoring technologies, railroad track networks are now frequently scanned using digital equipment and analyzed with the assistance of computer systems and specialized software. This introduces a fresh challenge of aligning and harmonizing the substantial volumes of data gathered during these measurement operations, which may involve distinct equipment and spans of time ranging from weeks to several months.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

In some aspects, the techniques described herein relate to a method for aligning linear network railway track measurement data corresponding to a segment of railway track collected during time-separated track measurement campaigns, the method including: receiving first linear network railway track measurement data collected during a first track measurement campaign performed during a first time period, wherein the first linear network railway track measurement data includes first data corresponding to a shape and condition of a geographical segment of track during the first time period; receiving second linear network railway track measurement data collected during a second track measurement campaign performed during a second time period, wherein the second linear network railway track measurement data includes second data corresponding to the shape and condition of the geographical segment of track during the second time period; and geographically aligning the first and second linear network railway track measurement data collected during the first and second measurement campaigns using the first and second data corresponding to the shape and condition of the geographical segment of track collected in the first and second measurement campaigns to thereby generate first aligned data.

In some aspects, the techniques described herein relate to a method, wherein the first and second data corresponding to the shape and condition of the geographical segment of track includes curvature data for one or more curves included in the geographical segment of track, geographically aligning the first and second geometric railway track measurement data includes: determining slopes of the one or more curves of the geographical segment of track based on the curvature data; identifying a beginning and ending of the one or more curves based on the slopes of a first transition zone and second transition zone; and aligning the beginning and ending of the curves.

In some aspects, the techniques described herein relate to a method, where the first and second linear network railway track measurement data further includes one or more of track shape data, track profile data, track alignment data, curvature data, rail shape data, rail profile data, rail wear data, third rail data, or rail overhead wire data.

In some aspects, the techniques described herein relate to a method, wherein the first and second linear network railway track measurement data is collected in one of a table, a matrix, or a graph.

In some aspects, the techniques described herein relate to a method, wherein the first and second linear network railway track measurement data stored in the table or matrix includes time data that specifies a sequential time relationship between the first and second linear network railway track measurement data.

In some aspects, the techniques described herein relate to a method, wherein the second linear network railway track measurement data includes fewer measurement points than the first geometric railway track measurement data, the method geographically aligning the first and second linear network railway track measurement data even though the second linear network railway track measurement data includes the fewer measurement points.

In some aspects, the techniques described herein relate to a method, wherein the geographical segment of track is located between one of two towns, two railroad switches, or two railroad stations.

In some aspects, the techniques described herein relate to a method, wherein the second linear network railway track measurement data is offset from the first linear network railway track measurement data, wherein geographically aligning the first and second linear network railway track measurement data includes: applying an offset value to the second linear network railway track measurement data so as to shift the second linear network railway track measurement data to align with the first linear network railway track measurement data.

In some aspects, the techniques described herein relate to a method, wherein the first and second linear network railway track measurement data are aligned without the use of an Absolute Position Based system or method or a Relative Position Based system or method.

In some aspects, the techniques described herein relate to a method, further including: receiving third linear network railway track measurement data collected during a third measurement campaign performed during a third time period, wherein the third linear network railway track measurement data includes third data corresponding to the shape and condition of the geographical segment of track during the third time period; and geographically aligning the third linear network railway track measurement data collected during the third measurement campaign with the first aligned data using the third data corresponding to the shape and condition of the geographical segment of track collected in the third measurement campaign to thereby generate second aligned data.

In some aspects, the techniques described herein relate to a method, wherein the first and second measurement campaigns collect the first and second railway track measurement data about every 25 centimeters. In another aspect, the first and second measurement campaigns collect the first and second railway track measurement data at intervals less than every three meters.

In some aspects, the techniques described herein relate to a method, further including: analyzing the first aligned data; and based on the analysis, characterizing a progression of one or more track defects in the geographical segment of track.

In some aspects, the techniques described herein relate to a computing system including: a processor; a non-transitory computer readable storage medium having stored thereon computer readable instructions that, when executed by the processor, cause the computing system to perform a process of automatically aligning different rail track segment measurement campaigns, the computing system caused to: receive linear network railway track measurement data associated with a plurality of measurement campaigns for a geographic segment of rail track; and for each measurement campaign received: identify a curvature of measurement points along the geographic segment of rail track; determine a slope for the measurement points of a curve; identify a beginning and an end of at least one curve located within the segment of track based upon a relative value of the slope compared to a threshold; align the beginning of the at least one curve; and align the end of the at least one curve.

In some aspects, the techniques described herein relate to a computing system, the computing system further caused to: generate aligned linear network railway track measurement data that includes the linear network railway track measurement data of the plurality of measurement campaigns for the segment of rail track that has had the beginning and the end of the least one curve aligned.

In some aspects, the techniques described herein relate to a computing system, wherein the segment of rail track is located between one of two towns, two railroad switches, or two railroad stations.

In some aspects, the techniques described herein relate to a computing system, where the linear network railway track measurement data includes one or more of track shape data, track profile data, track alignment data, curvature data, rail shape data, rail profile data, rail wear data, third rail data, or rail overhead wire data.

In some aspects, the techniques described herein relate to a computing system, wherein the geographic segment of rail track includes a plurality of curves, the method further including: identify a beginning and an end of the plurality of curves located within the segment of track based upon a relative value of the slope compared to a threshold; align the beginning of the plurality of curves; and align the end of the plurality of curves.

In some aspects, the techniques described herein relate to a computing system, the computing system further caused to: apply an offset value to the linear network railway track measurement data of one of the plurality of measurement campaigns.

In some aspects, the techniques described herein relate to a computing system, wherein the linear network railway track measurement data of one of the plurality of measurement campaigns includes less measurement points than the linear network railway track measurement data of at least one other of one of the plurality of measurement campaigns.

In some aspects, the techniques described herein relate to a method of aligning measurement data for a segment of railway track, including: receiving a first set of linear network railway track measurement data relating to the physical characteristics of the segment of railway track; receiving a second set of linear network railway track measurement data relating to the physical characteristics of the segment of railway track; and aligning the first set of linear network railway track measurement data with the second set of linear network railway track measurement data using the physical characteristics of the segment of railway track to align the physical characteristics to a track shape.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 discloses aspects of a measurement train.

FIG. 2 discloses aspects of a track segment transitioning from tangent section to a curve and back to a tangent section.

FIGS. 3A-3C disclose aspects of aligning the beginning and end of curves of a track segment;

FIGS. 4A-4C disclose aspects of determining a slope of a transition of a curve.

FIGS. 5A-5B disclose aspects of aligning incomplete linear network railway track measurement data.

FIGS. 6A-6B disclose aspects of applying offset values to linear network railway track measurement data.

FIG. 7 discloses aspects of a method according to one embodiment.

FIG. 10 discloses a computing entity configured and operable to perform any of the disclosed methods, processes, and operations.

FIG. 8 discloses aspects of a method according to one embodiment.

FIG. 9 discloses aspects of a method according to one embodiment.

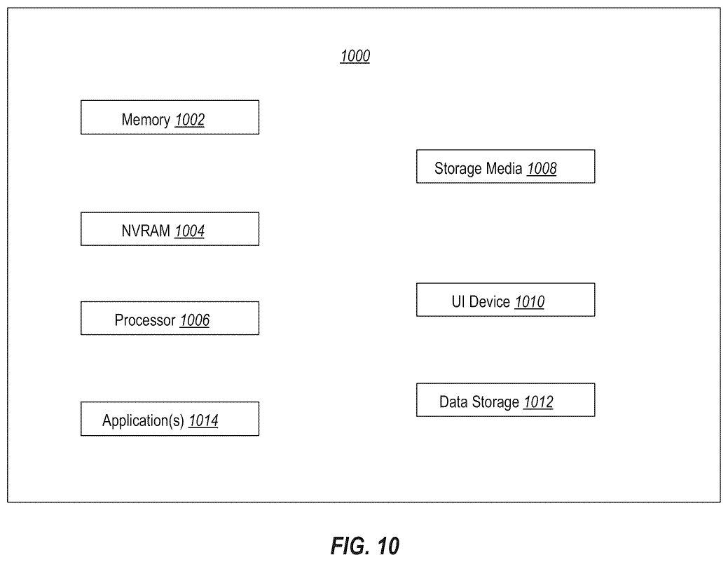

FIG. 10 discloses a computing entity configured and operable to perform any of the disclosed methods, processes, and operations.

### DETAILED DESCRIPTION

Track measurement trains are responsible for conducting track measurements during a track measurement campaign. A track measurement campaign involves assessing a segment of several kilometers and collecting various standardized measurement signals. In some embodiments, there are nine standardized measurement signals that are collected, which include: Curvature, Rail measurements (Top wear, Side wear, head loss, rail profile), and Track alignment (Top alignment, Line alignment, Twist, Superelevation). These measurement signals are recorded at measurement points that are typically spaced every 25 cm along the track, although the measurement points can be spaced at other distances as needed, for example newer technologies may collect measurements in increments less than every 25 cm and older technologies may collect measurements greater than every 25 cm. Nevertheless, to order to provide measurement data useful enough to track rail wear, measurements should be collected at least every three meters. To ensure track safety, the most monitored measurements include curvature, super elevation, multiple-line measurements, multiple-top measurements, and rail profile measurements. Precise and clean data alignment is crucial for monitoring the progression of defects in the rail for Root Cause Analysis. This precision is necessary to distinguish actual rail defects from any noise that may arise during the alignment of data collected from different track measurement campaigns.

Typically, the identification and tracking of track defects with specific wavelengths (λ) are categorized as follows: D0 (1<λ≤5 m), D1 (3<λ≤25 m), D2 (25<λ≤70 m), and D3 (70<λ≤150 m) are accomplished using either manual inspections or threshold analysis. However, both of these methods fall short in meeting the requirements for condition-based maintenance due to their computational complexity, time-consuming nature, and lack of predictive capabilities. To effectively capture the progression of these defects, the correction of positional errors is crucial. Through experimentation, it has been determined that employing data from eight track measurement campaigns or runs, within one life cycle (a life cycle being from track installation to replacement of a given segment of track), is the preferred approach for accurately identifying the growth of defects over time. Although fewer than eight data sets can still be useful and valuable, utilizing eight sets of measurement data has been demonstrated to provide a robust dataset without introducing unnecessary delays in the process by waiting for additional redundant data.

To align these multiple track measurement campaigns or runs, track reference points are currently used. The two methods of determining reference points can be divided as follows:
APB (Absolute Position Based), that utilize, for example, GPS (Global Positioning System) and LRS (Linear Referencing System) for alignment of measurement points
RPB (Relative Position Based), based on historical track measurement campaigns (for reference), such as between two switches or junctions of the track.

Aligning the data from various track measurement campaigns and/or from different measurement vehicles has several challenges, including:
Incorrect alignment of several track measurement campaigns of the same measuring vehicle
Difference in alignment due to dynamically and statically acquired datasets (location)
Difference in location accuracy due to the use of different systems
Those measurement results that are invalid but cannot be identified as outliers.

These track reference points are currently supplier/client-dependent or not available at all. Based on the two existing methods of determining reference points, it is necessary to make a determination of which of the two to use to give the best alignment considering two main types of tracks: curved track and tangent sections. However, regardless of which method is chosen, the following problems often occur:
1. Depending on the size of the rail network, an owner will have one or multiple track measurement trains each having a measurement system. The multiple track measurement trains will have a positional offset from each other. This will happen when the same track measurement train measures the track multiple times but can be more severe when different track measurement trains/systems are used.
2. Using APB and/or RPB, the data from the different measurement systems of the different track measurement trains will always have a misalignment. Depending on the track measurement train's age and the measurement systems on board, this can commonly vary within 2 meters, but variations up to 10 meters can occur. With such large variations in the measurement systems, accurately tracking isolated degradations in the track becomes impossible. Also, sometimes the measurement systems will not measure a part of a track. This part of the track can be from just a few meters to several kilometers. This break in the linear measurement makes it difficult to re-align the data automatically using APB and/or RPB.
3. The determined reference points used can be far apart depending on the distance of switches, RFID (Radio Frequency Identification) or other chosen method. This also means that all track measurement trains need to be equipped with a device to measure the reference points.

It will be noted that the second point above (2) makes it impossible when using APB and/or RPB to automate the prediction of short-medium wave failures with accuracy.

Thus, there is a need for an automated solution for reconciling different data sets of information from different track measurement campaigns or runs using different reference/datum methodologies into a single model of the track. Ideally, this solution should be independent of any reference data that is not inherently part of the collected track data, in other words is not part of the collected data that is part of the geometric or physical elements of a track segment. What is also needed is a way of integrating and using incomplete and poor data sets into a final model. With a reconciled data set of a segment of track being analyzed, it becomes possible to predict various wavelength irregularities automatically at an earlier stage. Regardless of the supplier, this will give the data users a way of predicting D0 to D3 defects for the track.

The embodiments disclosed herein solve the above discussed problems and provide end users with or without APB (Absolute Position Based) or RPB (Relative Position Based) reference points with an automated solution to accurately align multiple track measurement campaigns to allow for the prediction of D0 to D3 wavelength defects in the track, or in other words to characterize the progression of track defects. The alignment is automatically performed in software on a computer with minimal user involvement. Such software can be local hard drive-based or cloud-based.

In the embodiments disclosed herein, a geographical (i.e., the physical location of the portion of track) segment of track being measured is first generally identified. The geographical segment of track can be identified as being between one of two towns, two railroad switches, or two railroad stations. Of course, other reference points can also be used to identify the geographical segment of track. In some embodiment, the geographical segment of track can be identified through an APB or RPB technique. It will be appreciated, however, that general identification of the geographical segment of track simply denotes the geographical segment of track, such as a segment between two railroad switches, or two towns, or between two railroad stations. Thus, use of an APB or RPB technique to identify a geographical segment of track is a broad categorization, and is not to be considered an alignment of any linear network railway measurement data, so that a computer can identify that the sets of linear network railway track measurement data to be aligned are from the same geographical segment of track.

Once linear network railway track measurement data for a specific geographical segment of track is collected by various track measurement campaigns, the linear network railway track measurement data is imported into the computer. In the current embodiment, combining/reconciling the various track measurement campaigns, which in one embodiment will be at least eight track measurement campaigns within one life cycle, will provide a preferred resolution of linear network railway track measurement data to follow the progression of certain track defects. As the multiple linear network railway track measurement data sets are combined into matrices of data, the date each dataset was collected is maintained. The linear network railway track measurement data may be organized into a matrix or track model sequentially by date; this way changes in the amplitude of track parameters can be monitored over time.

For a given geographical segment of track scanned during a track measurement campaign, a measurement will be taken every 25 cm along the geographical segment of track, though this measurement interval can vary as needed. The locations where the linear network railway measurements are taken are called “measurement points.” In the embodiments disclosed herein, for each measurement point, the curvature of the track is measured. The curvature can be identified by a chord, arc, transition zone, and/or curve radius of each measurement, all referred to as “curve” herein. At each measurement point, the slope of the curve can be determined. By looking at the slope of the curvature of each measurement point, curved and tangent sections of the track segment can be mathematically calculated. For a straight piece of track (called a tangent) the slope measurement will simply be zero or close to zero.

In the embodiments, the curve slope data is used as the primary alignment feature and does not need any geographical or physical non-track measurement reference points, such as GPS or LRS generated reference points, or absolute measurement points to align different linear network railway track measurement data sets of tracks. In other words, in the embodiments disclosed herein the linear network railway measurements are aligned without the use of the Absolute Position Based method or the Relative Position Based method. Instead, all reference points in the embodiments disclosed herein are taken directly from the track collected inherently as part of the track measurement campaigns such that no additional APB and RPB data need to be collected to extract this alignment information. Since alignment does not depend on external features, the linear network railway track measurement data being analyzed to determine the quality of the track is also the linear network railway track measurement data being used to align the different track measurement campaigns.

This makes alignment of multiple measurement track campaigns extremely accurate and makes track defects easier to identify. In addition, computing resources are reduced since there is a straightforward way to align the data of the multiple measurement track campaigns. Further, user experience is improved as the track defects are found earlier, thus allowing for repairs and the like to be performed sooner, which in turn improves the railway track network.

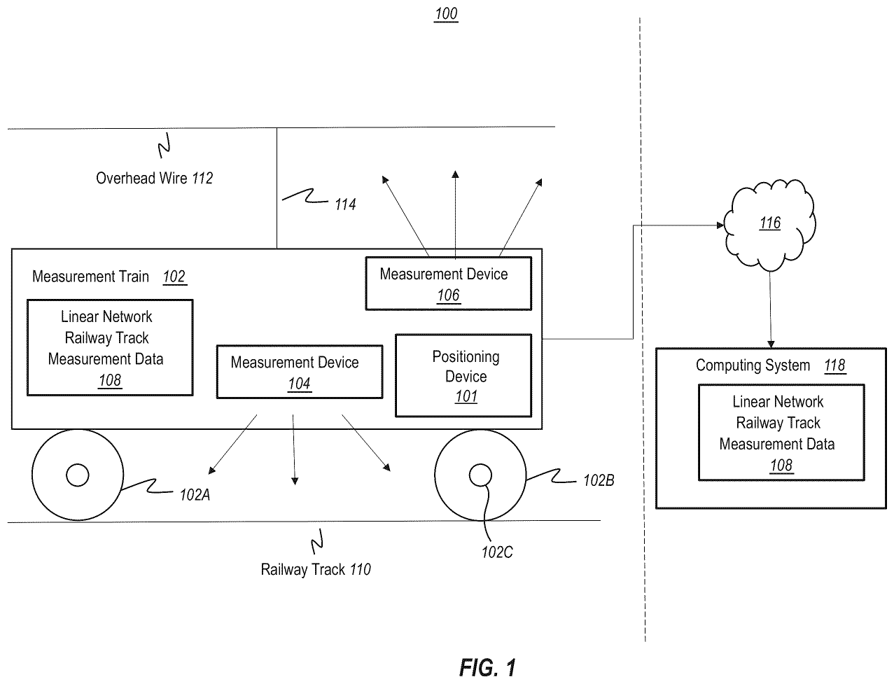

FIG. 1 illustrates an environment 100 where the embodiments disclosed herein may be practiced. As illustrated, FIG. 1 includes a track measurement train 102. It will be appreciated that the track measurement train 102 is a simplified illustration for ease of explanation. Thus, in operation the track measurement train 102 may include additional elements not shown in the figure. In addition, some of the elements described in relation to the track measurement train 102 may be included in one or more additional rail cars as the track measurement train 102 may be an engine or a rail car pulled by the engine in different embodiments. Thus, the track measurement train 102 represents any reasonable implementation of a track measurement train. Accordingly, the embodiments and the claims disclosed herein are not limited by the actual implementation of the track measurement train 102.

As illustrated, the track measurement train 102 includes a wheel 102A and a wheel 102B that are able to run on a railway track 110. In some embodiments, the track measurement train 102 may be an electric train that is connected to a railroad overhead electric wire 112 via a connector 114 that allows the track measurement train 102 to receive electric current from the railroad overhead electric wire 112. Of course, in embodiments where the track measurement train 102 is not an electric train, the track measurement train 102 need not include the connector 114.

The track measurement train 102 also includes a measurement device or system 104 and a measurement device or system 106. The measurement device 104 represents all the various measurement devices and sensors that are implemented in the track measurement train 102 to measure and collect track shape data, track profile data, track alignment data, curvature data, rail shape data, rail profile data, third rail data, and rail wear data. The measurement device 104 also identifies the measurement points, which is the locations where the linear network railway measurements are taken. In one embodiment, the measurement points may be specified in meters from a beginning point, such as a rail switch, a train station, or a town. The measurement device 106 represents all the various measurement devices and sensors used to measure and collect railway overhead wire data, for example data related wire length, the shape of the wire, is the wire twisted, or are there any defects in the wire. It will be appreciated that in some embodiments, the various measurement devices and sensors of the measurement devices 104 and 106 may be located in any location in the track measurement train 102.

In some embodiments, the measurement train 102 includes a positioning device 101. The positioning device 101 measures a relative position of the measurement train 102 as it moves along the railway track 110. In some embodiments, the positioning device 101 is able to determine the measurement points that are used by the embodiments disclosed herein. In addition, a counter 102C is included on the wheel 102B, although in some embodiments a counter may also be included on the wheel 102A. The counter 102C may be used in conjunction with the positioning device 101 to measure the relative position of the measurement train 102 as it moves along the railway track 110.

The measured track shape data, track profile data, track alignment data, curvature data, rail shape data, rail profile data, rail wear data, and rail overhead wire data, and any other data collected by the measurement devices 104 and 106, along with the collected measurement points collected by the positioning device 101 and counter 102C, are referred to herein as linear network railway track measurement data 108 in the figure. The linear network railway track measurement data 108 is then provided to a computing system 118 via a network 116. In an embodiment, the computing system 118 is remote from the track measurement train 102, although this need not be the case.

The linear network railway track measurement data 108 can be measured or collected during a number of track measurement campaigns, which as previously described is preferably eight track measurement campaigns or more, although this is not required, but may be two, three, four, five, six, or seven track measurement campaigns. The computing system 118 can then use the linear network railway track measurement data 108, that is the track measurement data and the measurement points, from all of the track measurement campaigns to align the linear network railway track measurement data 108 as will be explained in more detail to follow. Once the linear network railway track measurement data 108 from all of the track measurement campaigns is aligned, the aligned data set can be used to characterize a progression of track defects by a user of the computing system 118.

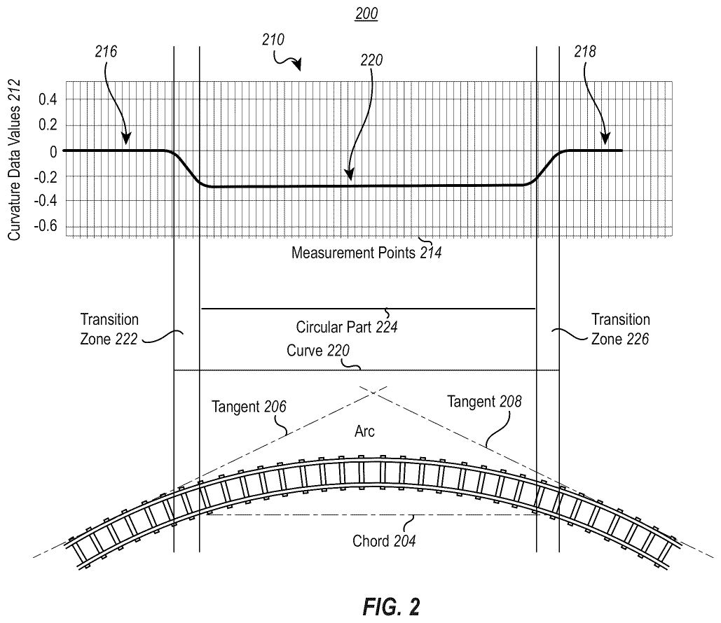

FIG. 2 illustrates a railway track segment 200 transitioning from a straight section (referred to as a tangent track) to a curve, and then back to a straight section. Within any given curve, there are elements such as an arc 202, a chord 204, and a radius at various points along the curve's trajectory. This curvature data can be extracted and compiled from the linear network railway track measurement data 108 collected during the various track measurement campaigns. For each measurement point, the curvature data can be extracted and either plotted on a graph or organized into a matrix or a table.

FIG. 2 illustrates a graph or plot 210, where curvature data values 212 are graphed against their respective measurement points 214. In the graph 210, when the track segment 200 is in a straight alignment, the curvature data value 212 remains close to zero as shown at 216 and 218. During the transition from a straight section to a curve, such as the transition from the straight section 216 to a curve (or curved section) 220 or from the transition from the curve 220 to the straight section 218, the graph exhibits a noticeable change in slope, which can be either positive or negative, depending on the direction of the curve relative to a reference point established within the system.

FIG. 2 illustrates a first transition zone 222 where the straight section 216 transitions to the curve 220. In the embodiment, the curvature data value 212 goes from near 0 to −0.3 in the first transition zone 222. When the first transition zone 222 culminates in the continuous arc 202, the curvature data value 212 changes less abruptly, resulting in a flatter portion 224 of the graph, that can, however, still be somewhat circular, since the curvature remains relatively constant. As the flatter, circular portion 224 of the railway track segment 200 concludes and transitions from the curve 220 to the straight section 218, the graph 210 shows a second transition zone 226. In the embodiment, the curvature data value 212 goes from near −0.3 to near 0 in the second transition zone 222. The beginning and end of each transition zone, such as the transition zones 222 and 226, creates transition points as will be discussed in more detail to follow. Thus, as described herein the curve 220 includes the transition zones 222 and 226 and the flatter, circular portion 224 and the transition zones 222 and 226 (or also simple “transition” herein) can be considered the beginning or start and the end of the curve 220. In some embodiment, depending on axle loads and speeds above a certain limit, the curve 220 will behave as a tangent such as tangent 206 or 208. In such embodiment, the curve 220 can be processed as a tangent.

Analyzing the values of the change in curvature reveals readily identifiable changes in the line plot as shown in FIG. 2 which can be extracted and analyzed. At measurement points where the track segment's curvature suddenly changes, it is possible to create a reference point that can align the linear network railway track measurement data 108 from different track measurement campaigns. This way, the linear network railway track measurement data 108 dataset is divided into a predefined number of smaller segments, separated by the initiation or termination of a curve and transition in the track segment. Also, the curves or at least the circular parts of the curve, are separated from the tangents. Curved portions of the track segment are susceptible to different failure modes than straight track. Thus, by separating the different portions of the track segment, tools customized to analyze tangents or curves can be used on each respective data set.

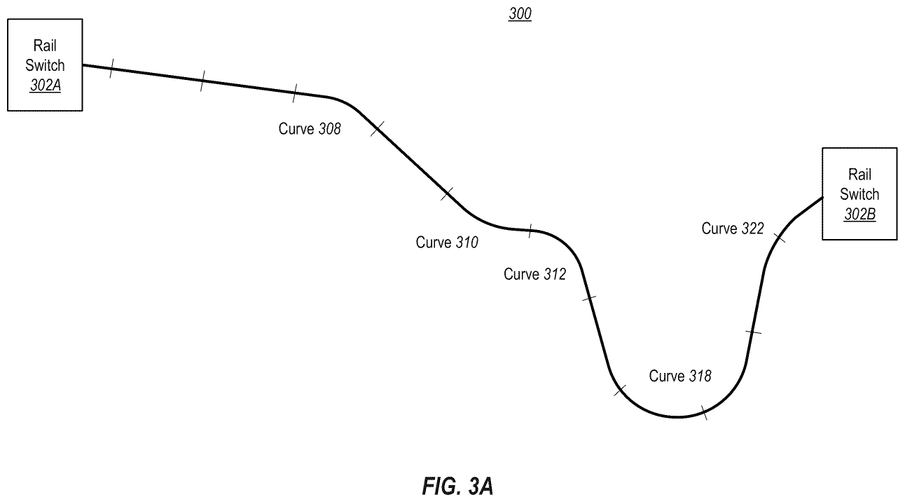

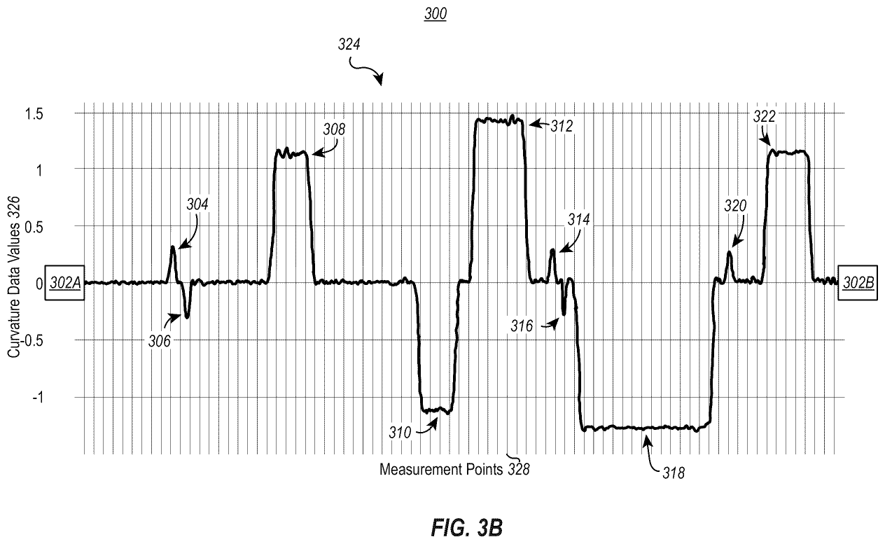

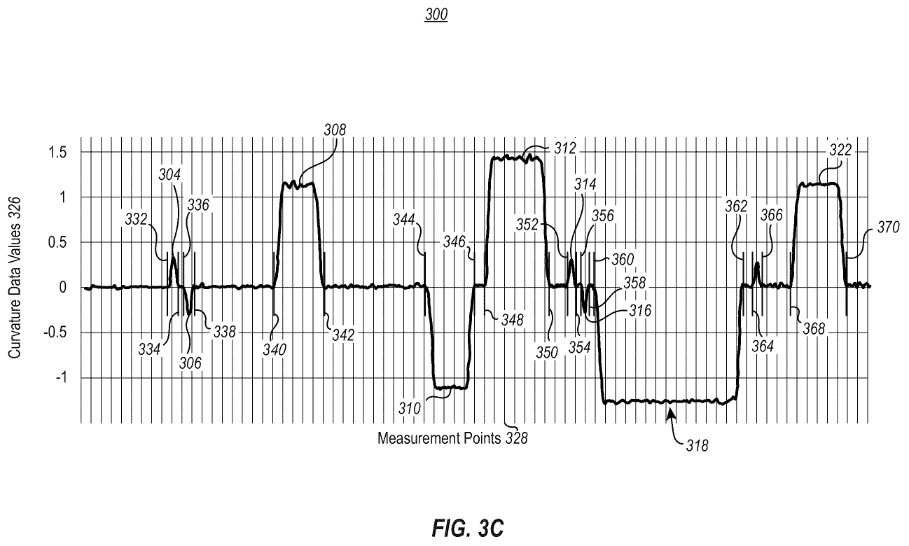

FIG. 3A shows an exemplary aerial view of a railway track segment 300 that runs for approximately 11 km from a rail switch 302A to a rail switch 302B. The curvature data compiled and extracted from the linear network railway track measurement data 108 datasets of the track segment 300 is shown in a graph or plot 324 of FIG. 3B, where curvature data values 326 are graphed against their respective measurement points 328. In the embodiment, a “general identification” of the track segment is established as the track segment between the rail switch 302A to the rail switch 302B. As discussed previously, the general identification is not used for alignment but is used to identify linear network railway track measurement data 108 datasets that are to be aligned using the embodiments described herein.

As shown in FIGS. 3A and 3B, the complete track segment 300 run has 10 curves over the 11 km run. These are curve 304, curve 306, curve 308, curve 310, curve 312, curve 314, curve 316, curve 318, curve 320, and curve 322. It should be noted that curve 304, curve 306, curve 314, curve 316, and curve 320 are shown on the graph 324 of FIG. 3B, but are not visible in the aerial view of the track segment 300 in FIG. 3A. This is because these curves, while abrupt, are too small to be visible in an aerial view of 11 km of the track segment 300. The short abrupt curves may direct the track segment around an obstacle. Such minor curves in the track segment, though not visible on a map, are valuable data points that can be exploited by the embodiments disclosed herein to align the linear network railway track measurement data 108 from the different measurement campaigns.

FIG. 3C illustrates an embodiment where the curves 304-322 provide 20 reference points, including a start and end for each curve. In other words, the reference points specify where the transition zones are located for each of the curves as the curve begins at a first transition zone (e.g., first transition zone 222) and ends at a second transition zone (e.g., second transition zone 226). FIG. 3C illustrates horizontal line indicators at the beginning and end of each of the curves 304-322 showing the 20 new reference points created. In FIG. 3C, a horizontal line indicator shows a reference point 332 at the beginning of the curve 304 and a horizontal line indicator shows a reference point 334 at the end of the curve 304. A horizontal line indicator shows a reference point 336 at the beginning of the curve 306 and a horizontal line indicator shows a reference point 338 at the end of the curve 306. A horizontal line indicator shows a reference point 336 at the beginning of the curve 306 and a horizontal line indicator shows a reference point 338 at the end of the curve 306. A horizontal line indicator shows a reference point 340 at the beginning of the curve 308 and a horizontal line indicator shows a reference point 342 at the end of the curve 308. A horizontal line indicator shows a reference point 344 at the beginning of the curve 310 and a horizontal line indicator shows a reference point 346 at the end of the curve 310. A horizontal line indicator shows a reference point 348 at the beginning of the curve 312 and a horizontal line indicator shows a reference point 350 at the end of the curve 312. A horizontal line indicator shows a reference point 352 at the beginning of the curve 314 and a horizontal line indicator shows a reference point 354 at the end of the curve 314. A horizontal line indicator shows a reference point 356 at the beginning of the curve 316 and a horizontal line indicator shows a reference point 358 at the end of the curve 316. A horizontal line indicator shows a reference point 360 at the beginning of the curve 318 and a horizontal line indicator shows a reference point 362 at the end of the curve 318. A horizontal line indicator shows a reference point 364 at the beginning of the curve 320 and a horizontal line indicator shows a reference point 366 at the end of the curve 320. A horizontal line indicator shows a reference point 368 at the beginning of the curve 322 and a horizontal line indicator shows a reference point 370 at the end of the curve 322.

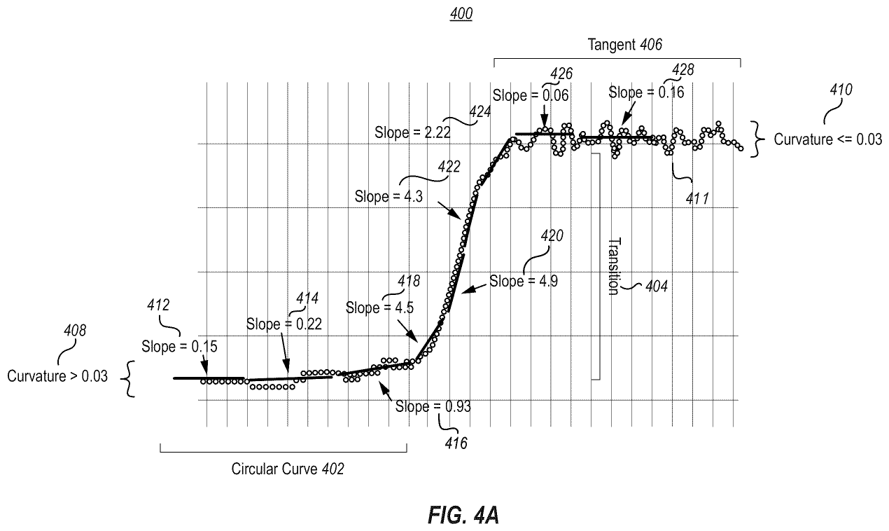

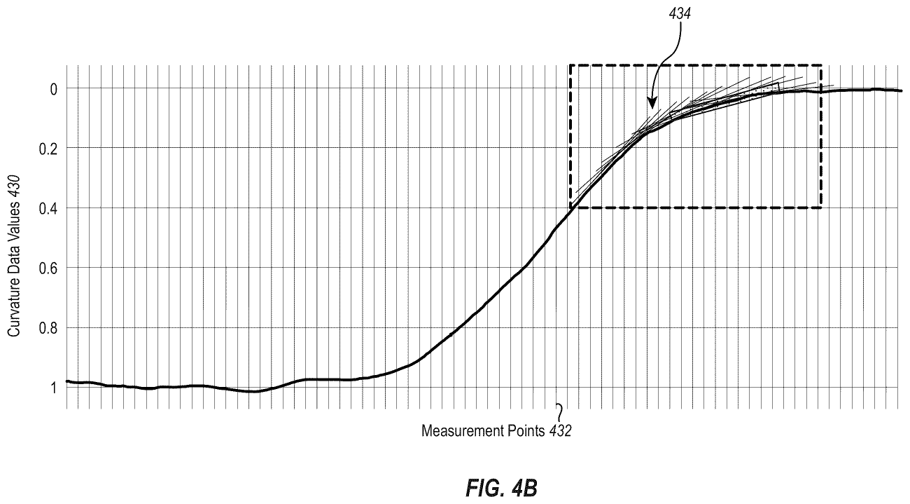

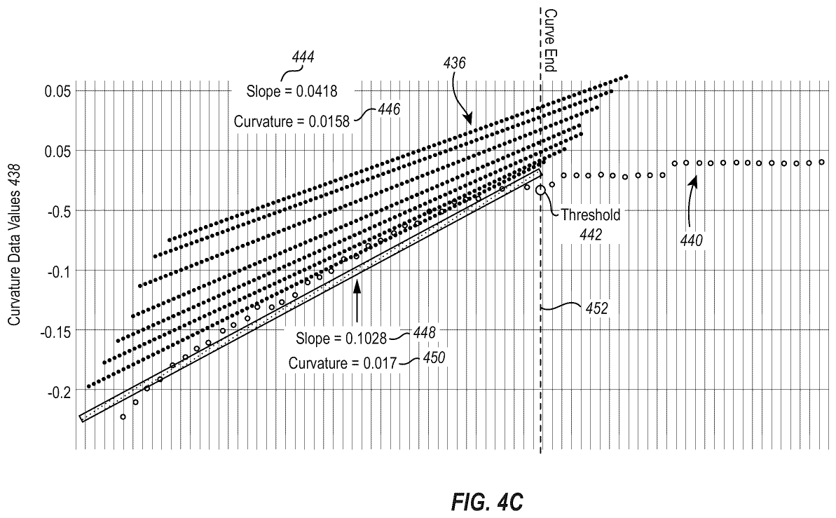

FIG. 4A illustrates a representative diagram 400 of an embodiment of a slope detection algorithm combined with curvature thresholds that can be used by the computing system 118 to accurately identify the start and end of locations of a curve so as to identify the reference points discussed previously. As illustrated, FIG. 4A illustrates a circular portion of a curve 402, a transition 404, and a tangent track 406. As illustrated, the circular portion of a curve 402 has a curvature 408 of around 0.03 and the tangent track has a curvature 410 of around 0.03. Since both of these curvature data values are near zero, it can be seen that the transition 404 has occurred between the circular portion of a curve 402 and the tangent track 406.

FIG. 4A also shows a series of slopes calculated from curvature data collected from a track measurement campaign. In one embodiment, for a section of track, data points 411 can be collected every 25 cm. For these data points 411 over a 30-meter section, a slope can be generated. This is then repeated for the following 30-meter section of track, where the slope measurement is joined to the first slope. The series of slopes combined linearly in the graph generates a total curve demonstrating the existing of transition from a tangent to the curve in the track.

For example, FIG. 4A shows the slopes of the data points 411 is aligned sequentially and joined with the earlier slopes. Thus, the circular portion of a curve 402 has a 30-meter section having a slope value 412 of 0.15, a 30-meter section having a slope value 414 of 0.22, and a 30-meter section having a slope value 416 of 0.93. The transition 404 has a 30-meter section having a slope value 418 of 4.5, a 30-meter section having a slope value 420 of 4.9, a 30-meter section having a slope value 422 of 4.3, and a 30-meter section having a slope value 424 of 2.22. The tangent track 406 has a 30-meter section having a slope value 426 of 0.06 and a 30-meter section having a slope value 428 of 0.16.

Thus, FIG. 4A shows that once the slope progresses to a certain value, a transition is clearly beginning or ending. For example, in FIG. 4A a slope value greater than 1.0 can indicate the beginning of the transition 404 as the slope values 418-424 are greater than 1.0 and the slope values 412-416 are lower than 1.0. Likewise, having the slope value return to below 1.0 can indicate the ending of the transition 404 as the slope values 426-428 are below 1.0. Accordingly, in FIG. 4A 1.0 can be considered a threshold value, where all slope values that have a higher value than the threshold indicate the beginning or ending of a transition.

FIG. 4B illustrates a further example of how the slope is used to indicate the beginning or ending of a transition zone. FIG. 4B illustrates that curvature data values 430 can be calculated over a length of 30 meters for measurement points 432. In some embodiments, the measurement points 432 can be calculated every 25 centimeters. In other embodiments, the measurement points are calculated at intervals less than every three meters. For embodiments with a lower measuring distance, the lower distance will be used. In the plot, as shown at 434 a series of slopes are plotted sequentially on top of one another during a transition. This visualizes the series of slopes that will be evaluated by the computing system 118.

FIG. 4C illustrates an example of how a threshold is determined. In FIG. 4C, the slopes 436 and curvature data values 438 of a series of measurement points 440 are shown on the graph. Each dot represents a measurement point 440 and each of those measurement points will have a slope 436 value and a curvature data value 438 that can be used to identify a threshold 442 when the curve begins or ends. For example, one of the measurement points has a slope value 444 of −0.0418 and a curvature data value 446 of −0.0158 and another one of the measurement points has a slope value 448 of 0.1028 and a curvature data value 450 of −0.017. In this graph, a line 452 indicates that the curve ends when the curvature measurement is greater than approximately −0.04, which thus becomes the threshold 442.

For each track measurement campaign, the same 20 reference points discussed previously in relation to FIG. 3C, at the beginning and end of the curves 304-322, will be identified and aligned by the computing system 118. For example, the 20 alignment points of track measurement campaign 1 will be aligned with the 20 alignment points of track measurement campaign 2. Afterwards subsequent measurement campaigns will be aligned to the composite (reconciled) data set of measurement campaigns 1 and 2. In one preferred embodiment, eight data sets will be reconciled (combined and aligned to be usable data) into a complete set of data that is much more easily and precisely analyzed for changes in status of the track segment 300. These 20 curve changes over the 11 km section provide 10× as many alignment points as using the rail switches 302A and 302B alone as alignment points, as is done in the RPB based method. In addition, this large number of alignment points is obtained without the need to use GPS and LRS systems that are used in the APB based method. It is geometric (i.e., shape of the track measured) or physical reference alignment points, such as those discussed above in relation to FIG. 3C, based on the actual curves of the track segment that are used to align the linear network railway track measurement data in the embodiments disclosed herein.

Accordingly, the multiple sets of linear network railway track measurement data can be aligned to each other by means of the curve-based reference points. The reconciliation of the track measurement campaigns will align the physical locations of the measured track characteristics with each other.

The table, matrix, or other two-dimensional data structure where the linear network railway track measurement data 108 is organized and that is used by the computing system 118 when aligning the data may include a large amount of information for each track segment. For example, for the 11 km track segment 300 measured every 25 cm, there will be about 44,000 measurement points. For linear network railway track measurement data including the nine standardized measurement signals previously discussed, this will include nine measured characteristics for each measurement point. If eight measurement campaigns are compiled, this results in 72 measured characteristics for each of the 44,000 measurement points. Thus, the embodiments disclosed herein, by using the geometric or physical reference alignment points based on the actual, geographical curves of a track segment, are able to accurately align even data even when there is 72 measured characteristics for each of the 44,000 measurement points without the need for any other alignment method or system.

As this data is compiled into the matrix, the time which each measurement campaign was conducted can also be maintained in the matrix. Additionally, usage data of the track segment, such as tonnage of train traffic or other usage data between each measurement campaign may be captured and compiled in the matrix. Preferably the matrix will organize the data sequentially, thus allowing changes in any of the measured characteristics, such as rail profile or other track geometry, to be easily tracked. The data may also be scaled by MGT (Mass Gross Tonnage) which has moved across the segment between intervals between measurements or time, this way if several measurement campaigns occur in a brief period or low MGTs, sequential weeks or view tons, they can be aligned to campaigns that may have occurred farther apart in MGT or time, months a part or MGTs. This will keep the data linear for analysis.

In some instances, one or more of the eight track measurement campaigns may not be completed. This is because the track measurement train 102 may have a lower priority than the commercial trains for time on the railway network. In such instances, one or more incomplete track measurement campaigns may result in incomplete linear network railway track measurement data for the incomplete track measurement campaigns. Advantageously, the embodiments disclosed herein allow for the incomplete linear network railway track measurement data to be used since the linear network railway track measurement data from the various track measurement campaigns is aligned using the beginnings and endings of the physical, geographical track segment as will now be explained.

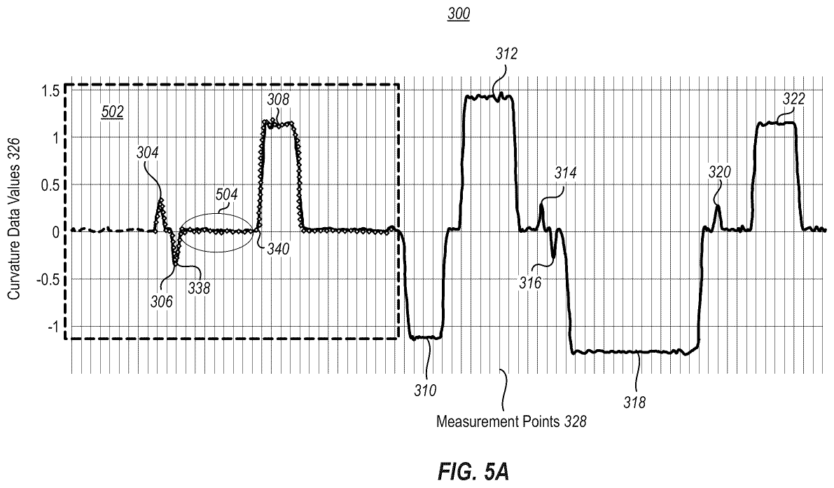

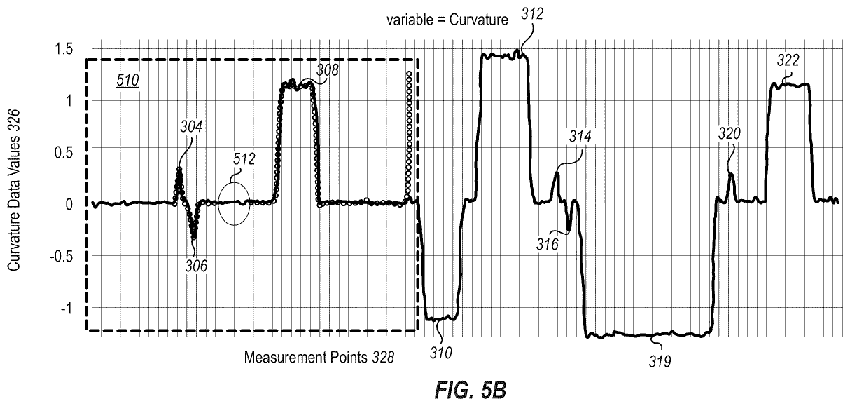

FIG. 5A illustrates an embodiment of the track segment 300 previously shown in FIGS. 3A-3C. In FIG. 5A, a first track measurement campaign is performed where linear network railway track measurement data is collected for the entire run of the track segment 300 including all of the curves 304-322. In addition, the figure shows an incomplete second track measurement campaign illustrated by the dashed box 502. Thus, during the second track measurement campaign, the track measurement train 102 was only able to collect linear network railway track measurement data up to the curve 310.

The linear network railway track measurement data collected during the incomplete second track measurement campaign would not be useful for either the APB method or the RPB system since the data does not include the two general identification points, such as the rail switches 302A and 302B, as the rail switch 302B would not be included in the measured data.

In the current embodiment, however, using the reference points based on the beginning and end of the curves allows for the use of the linear network railway track measurement data collected during the incomplete second track measurement campaign. For example, as discussed previously in relation to FIG. 3C, there are reference points located for each of the curves of the track segment 300 as the curve begins at a first transition zone and ends at a second transition zone. Thus, it is possible to use the reference point 338 indicating the end of the curve 306 and the reference point 340 indicating the beginning of the curve 308 to automate the alignment of the curves 306 and 308 and the tangent track connecting curves shown by the circle 504. In like manner, the reference points for the curves 304 and 306 and the reference points for the curves 308 and 310 discussed previously can be used to automate the alignment of these curves and the respective tangent tracks connecting these curves.

Thus, the reference points created on the start and end of curves make it possible to automate the alignment of any two curves and their connecting tangent track. So long as at least two contiguous transitions are included in the linear network railway measurement data, the curve data including the transition and data related to the tangent track between the transitions can be overlayed onto the total set of linear network railway track measurement data compiled by the computing system 118 for all the track measurement campaigns. Thus, incomplete linear network railway track measurement data or linear network railway track measurement data with different general identification points can be used in any analysis. This permits any subsection of the track segment that was subject to a track measurement campaign to be merged into a larger complete set of linear network railway measurement data. In other words, in the embodiment even though the linear network railway track measurement data collected during the second track measurement campaign includes fewer measurement points than the linear network railway track measurement data collected during the first track measurement campaign, the embodiment disclosed herein is still able to align the linear network railway track measurement data and use the incomplete data set of the second track measurement campaign that has measurement points.

FIG. 5B illustrates a further embodiment of the track segment 300 previously shown in FIGS. 3A-3C. In FIG. 5A, a first track measurement campaign where linear network railway track measurement data is collected for the entire run of the track segment 300 including all of the curves 304-322. In addition, the figure shows an incomplete second track measurement campaign illustrated by the dashed box 510. Thus, during the second track measurement campaign, the track measurement train 102 was only able to collect linear network railway track measurement data up to the curve 310. However, unlike FIG. 5A, there is a clear gap where data is missing, as shown by the circle 512. In this case, the reference points of the curves 304, 306, and 308 can be used for aligning the incomplete linear network railway track measurement data of the second track measurement campaign so that this data is able to be compiled into the matrix with all the linear network railway track measurement data of the other track measurement campaigns. However, since data is missing, none of the tangent track data included in the circle 512 between the reference points of the curves 306 and 308 will be usable. However, even only being able to use the curve data and not the tangent track data still provides for more measurement points in the compiled data set.

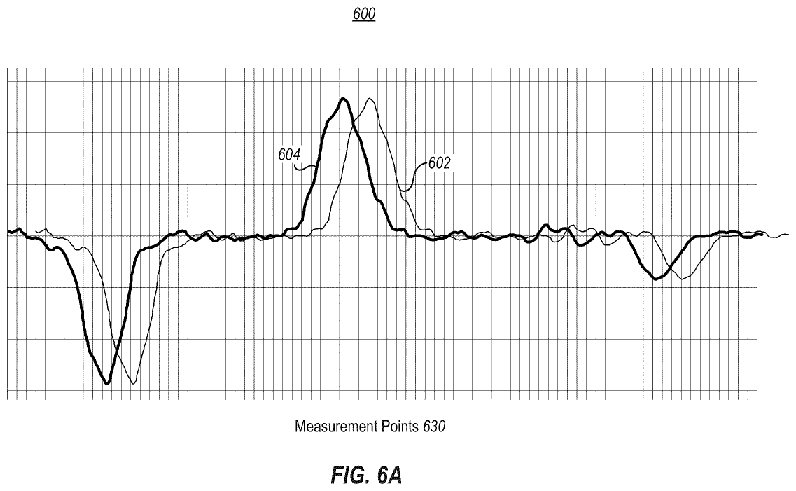

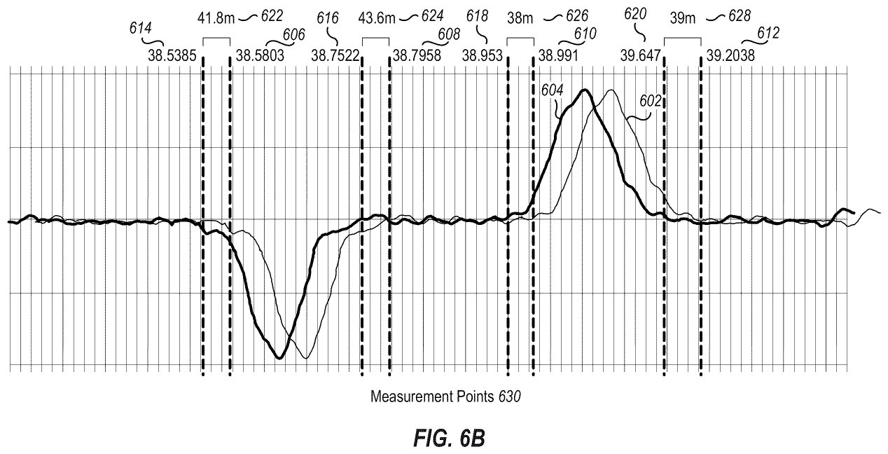

FIG. 6A illustrates an embodiment of linear network railway track measurement data collected from multiple track measurement campaigns or runs on a track segment 600. Each track measurement campaign is shown superimposed on top of one another. As can be seen 602, using the embodiments disclosed herein, the linear network railway track measurement data extracted from each track measurement campaign very closely maps the other track measurement campaigns. At times, however, when track measurement campaigns occur on different dates or under different conditions, the linear network railway track measurement data extracted from one or more of the track measurement campaigns may be offset from the other track measurement campaigns as shown at 604. In this situation, an offset value can be applied to shift the offset data to align with transitions of the earlier data.

FIG. 6B shows an alternative view of the embodiment of FIG. 6A. As shown in FIG. 6B, reference points of one of the track measurement campaigns included in 602 are shown at the beginning and ending of two curves identified in the manner previously described. For example, the figure shows reference points 606, 608, 610, and 612 and their corresponding measurement point 630 locations for the one of the track measurement campaigns included in 602. Likewise, FIG. 6B show reference points for the offset track measurement campaign shown at 604 at the beginning and ending of two curves. For example, the figure shows reference points 614, 616, 618, and 620 and their corresponding measurement point locations for the offset track measurement campaign shown at 604.

Once the reference points 606, 608, 610, and 612 and the reference points 614, 616, 618, and 620 are identified, offset values can be determined based on the reference points and their corresponding measurement point locations. For example, an offset value 622 is determined based on the difference between the measure point locations of the reference points 606 and 614, an offset value 624 is determined based on difference between the measure point locations of the reference points 608 and 616, an offset value 626 is determined based on difference between the measure point locations of the reference points 610 and 618, and an offset value 628 is determined based on difference between the measure point locations of the reference points 612 and 620. These offset values can be used to shift the linear network railway track measurement data extracted from the track measurement campaign shown at 604 to the linear network railway track measurement data extracted from the track measurement campaigns as shown at 602.

It is noted that any operation(s) of any of the methods disclosed herein, may be performed in response to, as a result of, and/or, based upon, the performance of any preceding operation(s). Correspondingly, performance of one or more operations, for example, may be a predicate or trigger to subsequent performance of one or more additional operations. Thus, for example, the various operations that may make up a method may be linked together or otherwise associated with each other by way of relations such as the examples just noted. Finally, and while it is not required, the individual operations that make up the various example methods disclosed herein are, in some embodiments, performed in the specific sequence recited in those examples. In other embodiments, the individual operations that make up a disclosed method may be performed in a sequence other than the specific sequence recited.

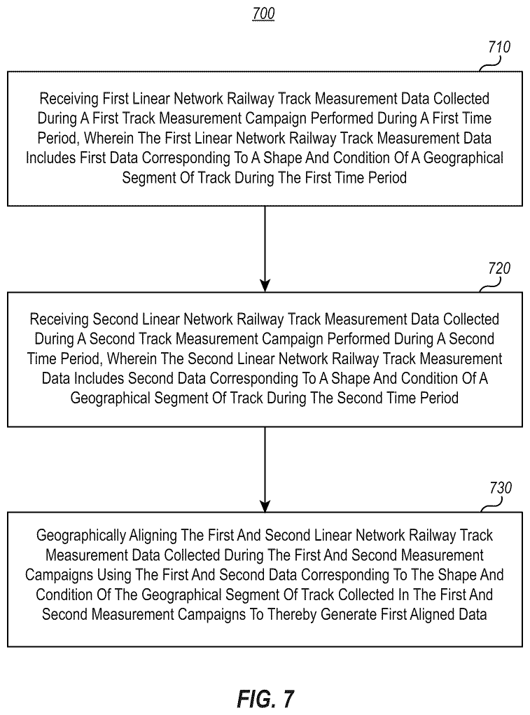

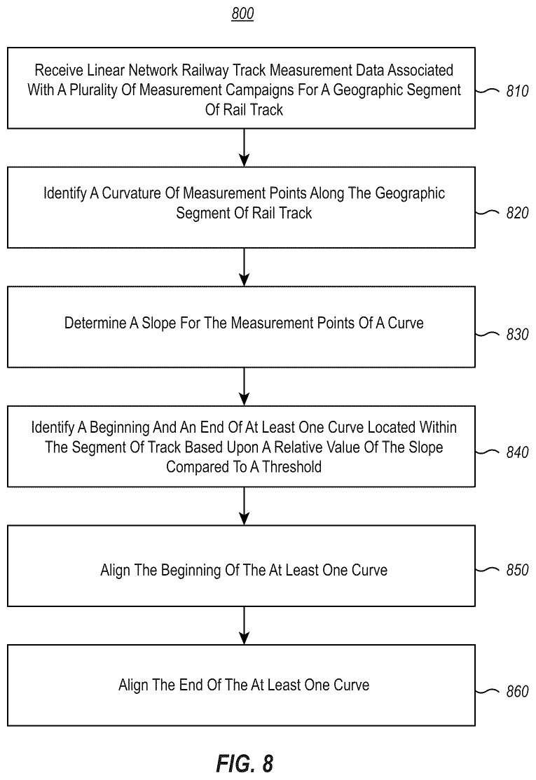

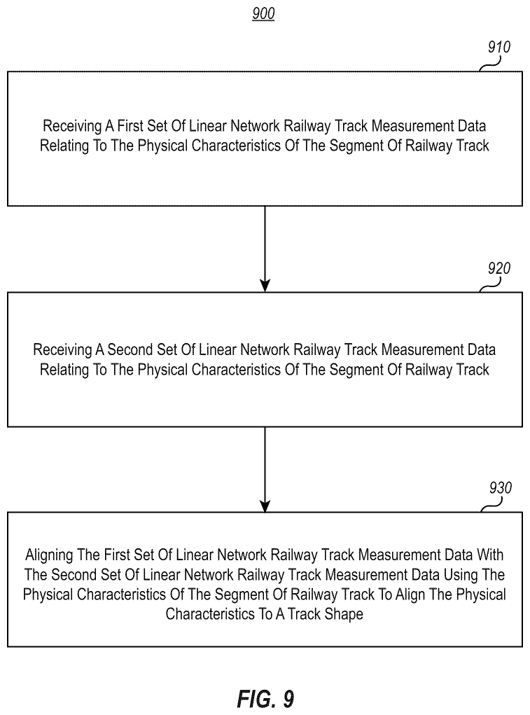

Directing attention now to FIG. 7, an example method 700 is disclosed. The method 700 will be described in relation to one or more of the figures previously described, although the method 700 is not limited to any particular embodiment.

The method 700 includes receiving first linear network railway track measurement data collected during a first track measurement campaign performed during a first time period, wherein the first linear network railway track measurement data includes first data corresponding to a shape and condition of a geographical segment of track during the first time period (710). The first linear network railway track measurement data 108 includes corresponding to a shape and condition of a geographical segment of track such as the track segment 200, 300, or 600. The data corresponding to a shape and condition of a geographical segment of track includes one or more sets of track geometric data, such as: curvature data, track shape data, track profile data, track alignment data, curvature data, rail shape data, rail profile data, rail wear data, third rail data, or rail overhead wire data.

The method 700 includes receiving second linear network railway track measurement data collected during a second track measurement campaign performed during a second time period, wherein the second linear network railway track measurement data includes second data corresponding to a shape and condition of a geographical segment of track during the second time period (720). For example, as previously described the computing system 118 receives the linear network railway track measurement data 108 that is collected during a second track measurement campaign. The second linear network railway track measurement includes data 108 corresponding to a shape and condition of a geographical segment of track such as the track segment 200, 300, or 600. The data corresponding to a shape and condition of a geographical segment of track includes one or more sets of track geometric data, such as: curvature data, track shape data, track profile data, track alignment data, curvature data, rail shape data, rail profile data, rail wear data, third rail data, or rail overhead wire data.

The method 700 includes geographically aligning the first and second linear network railway track measurement data collected during the first and second measurement campaigns using the first and second data corresponding to the shape and geometric characteristics of the geographical segment of track collected in the first and second measurement campaigns to thereby generate first aligned data (730). For example, as previously described the computing system 118 geographically aligns the first and second linear network railway track measurement data collected during the first and second measurement campaigns using the first and second data corresponding to the shape and condition of the geographical segment of track 200, 300, or 600. The alignment process is described throughout the embodiments disclosed herein, but in particular with respect to FIGS. 3A-3C, 4A-4C, and 5A-5B. Geographically aligning the first and second linear network railway track measurement data means that only data derived from or related to geometric or physical elements or characteristics of the track segment are used in the alignment process. For example, the geometric or physical elements or characteristics include, but are not limited to, the curvature and shape of one or more curves included in the track segment, including the transition zones of the curves. Thus, no data related to sources other than the geometric or physical elements or characteristics is used in the alignment process.

Directing attention now to FIG. 8, an example method 800 is disclosed. The method 800 will be described in relation to one or more of the figures previously described, although the method 800 is not limited to any particular embodiment.

The method 800 includes receive linear network railway track measurement data associated with a plurality of measurement campaigns for a geographic segment of rail track (810). For example, as previously described the computing system 118 receives the linear network railway track measurement data 108 that is collected during a first track measurement campaign for a track segment 200, 300, and 600.

The method 800 includes the steps, for each track measurement campaign: identify a curvature of measurement points along the geographic segment of rail track (820), determine a slope for the measurement points of a curve (830), identify a beginning and an end of at least one curve located within the segment of track based upon a relative value of the slope compared to a threshold (840), align the beginning of the at least one curve (850), and align the end of the at least one curve (860). For example, as previously described, primarily in relation to FIGS. 3A-3C, 4A-4C, and 5A-5B the computing system 118 identifies a curvature of measurement points along the geographic segment of rail track, determines a slope for the measurement points of a curve, identifies a beginning and an end of at least one curve located within the segment of track based upon a relative value of the slope compared to a threshold 442, aligns the beginning of the at least one curve, and aligns the end of the at least one curve.

Directing attention now to FIG. 9, an example method 900 is disclosed. The method 900 will be described in relation to one or more of the figures previously described, although the method 900 is not limited to any particular embodiment.

The method 900 includes receiving a first set of linear network railway track measurement data relating to the physical characteristics of the segment of railway track (910). For example, as previously described the computing system 118 receives the first set of linear network railway track measurement data 108 that is collected during a first track measurement campaign. The first linear network railway track measurement data 108 is related to physical characteristics such as the curvature and shape of one or more curves included in the track segment such as the track segment 200, 300, or 600.

The method 900 includes receiving a second set of linear network railway track measurement data relating to the physical characteristics of the segment of railway track (920). For example, as previously described the computing system 118 receives the second set of linear network railway track measurement data 108 that is collected during a second track measurement campaign. The second linear network railway track measurement data 108 is related to physical characteristics such as the curvature and shape of one or more curves included in the track segment such as the track segment 200, 300, or 600. Step 920 may be repeated for a third, fourth, fifth, sixth, seventh, eighth, or higher set of linear network railway measurement data. The subsequent sets of linear network railway measurement data being combined/reconciled into an aligned data set or matrix including the data from all of the collected measurement campaigns.

The method 900 includes aligning the first set of linear network railway track measurement data with the second set of linear network railway track measurement data using the physical characteristics of the segment of railway track to align the physical characteristics to a track shape (930). For example, as previously described the computing system 118 performs an alignment process described throughout the embodiments disclosed herein, but in particular with respect to FIGS. 3A-3C, 4A-4C, and 5A-5B based on the physical characteristics of the track segments 200, 300, and 600.

Finally, because the principles described herein may be performed in the context of a computing system (for example, such as the computing system 118) some introductory discussion of a computing system will be described with respect to FIG. 10. A computer may include a processor and computer storage media carrying instructions that, when executed by the processor and/or caused to be executed by the processor, perform any one or more of the methods disclosed herein, or any part(s) of any method disclosed.

As indicated above, embodiments within the scope of the present invention also include computer storage media, which are physical media for carrying or having computer-executable instructions or data structures stored thereon. Such computer storage media may be any available physical media that may be accessed by a general purpose or special purpose computer.

By way of example, and not limitation, such computer storage media may comprise hardware storage such as solid state disk/device (SSD), RAM, ROM, EEPROM, CD-ROM, flash memory, phase-change memory (“PCM”), or other optical disk storage, magnetic disk storage or other magnetic storage devices, or any other hardware storage devices which may be used to store program code in the form of computer-executable instructions or data structures, which may be accessed and executed by a general-purpose or special-purpose computer system to implement the disclosed functionality of the invention. Combinations of the above should also be included within the scope of computer storage media. Such media are also examples of non-transitory storage media, and non-transitory storage media also embraces cloud-based storage systems and structures, although the scope of the invention is not limited to these examples of non-transitory storage media.

Computer-executable instructions comprise, for example, instructions and data which, when executed, cause a general purpose computer, special purpose computer, or special purpose processing device to perform a certain function or group of functions. As such, some embodiments of the invention may be downloadable to one or more systems or devices, for example, from a website, mesh topology, or other source. As well, the scope of the invention embraces any hardware system or device that comprises an instance of an application that comprises the disclosed executable instructions.

Although the subject matter has been described in language specific to structural features and/or methodological acts, it is to be understood that the subject matter defined in the appended claims is not necessarily limited to the specific features or acts described above. Rather, the specific features and acts disclosed herein are disclosed as example forms of implementing the claims.

As used herein, the term ‘module’ or ‘component’ may refer to software objects or routines that are executed on the computing system. The different components, modules, engines, and services described herein may be implemented as objects or processes that execute on the computing system, for example, as separate threads. While the system and methods described herein may be implemented in software, implementations in hardware or a combination of software and hardware are also possible and contemplated. In the present disclosure, a ‘computing entity’ may be any computing system as previously defined herein, or any module or combination of modules running on a computing system.

In at least some instances, a hardware processor is provided that is operable to conduct executable instructions for performing a method or process, such as the methods and processes disclosed herein. The hardware processor may or may not comprise an element of other hardware, such as the computing devices and systems disclosed herein.

In terms of computing environments, embodiments of the invention may be performed in client-server environments, whether network or local environments, or in any other suitable environment. Suitable operating environments for at least some embodiments of the invention include cloud computing environments where one or more of a client, server, or other machine may reside and operate in a cloud environment.

With reference briefly now to FIG. 10, any one or more of the entities disclosed, or implied, by any of the previously discussed figures, and/or elsewhere herein, may take the form of, or include, or be implemented on, or hosted by, a physical computing device, one example of which is denoted at 500. As well, where any of the aforementioned elements comprise or consist of a virtual machine (VM), that VM may constitute a virtualization of any combination of the physical components disclosed in FIG. 10.

In the example of FIG. 10, the physical computing device 1000 includes a memory 1002 which may include one, some, or all, of random access memory (RAM), non-volatile memory (NVM) 1004 such as NVRAM for example, read-only memory (ROM), and persistent memory, one or more hardware processors 1006, non-transitory storage media 1008, UI device 1010, and data storage 1012. One or more of the memory components 1002 of the physical computing device 1000 may take the form of solid state device (SSD) storage. As well, one or more applications 1014 may be provided that comprise instructions executable by one or more hardware processors 1006 to perform any of the operations, or portions thereof, disclosed herein.

Such executable instructions may take various forms including, for example, instructions executable to perform any method or portion thereof disclosed herein, and/or executable by/at any of a storage site, whether on-premises at an enterprise, or a cloud computing site, client, datacenter, data protection site including a cloud storage site, or backup server, to perform any of the functions disclosed herein. As well, such instructions may be executable to perform any of the other operations and methods, and any portions thereof, disclosed herein.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for aligning linear network railway track measurement data corresponding to a segment of railway track collected during time separated track measurement campaigns, the method comprising:
receiving first linear network railway track measurement data collected during a first track measurement campaign performed during a first time period, wherein the first linear network railway track measurement data includes first data corresponding to a shape and condition of a geographical segment of track during the first time period;
receiving second linear network railway track measurement data collected during a second track measurement campaign performed during a second time period, wherein the second linear network railway track measurement data includes second data corresponding to the shape and condition of the geographical segment of track during the second time period; and
geographically aligning the first and second linear network railway track measurement data collected during the first and second measurement campaigns using the first and second data corresponding to the shape and condition of the geographical segment of track collected in the first and second measurement campaigns to thereby generate first aligned data.

2. The method of claim 1, wherein the first and second data corresponding to the shape and condition of the geographical segment of track includes curvature data for one or more curves included in the geographical segment of track, geographically aligning the first and second linear network railway track measurement data comprises:
determining slopes of the one or more curves of the geographical segment of track based on the curvature data;
identifying a beginning and ending of the one or more curves based on the slopes of a first transition zone and second transition zone; and
aligning the beginning and ending of the curves.

3. The method of claim 1, where the first and second linear network railway track measurement data further includes one or more of track shape data, track profile data, track alignment data, curvature data, rail shape data, rail profile data, rail wear data, third rail data, or rail overhead wire data.

4. The method of claim 3, wherein the first and second linear network railway track measurement data is compiled into one of a table, a matrix, or a graph.

5. The method of claim 4, wherein the first and second linear network railway track measurement data stored in the table or matrix includes one of i) time data that specifies a sequential time relationship between the first and second linear network railway track measurement data or ii) Mass Gross Tonnage (MGT) usage data.

6. The method of claim 1, wherein the second linear network railway track measurement data includes fewer measurement points than the first linear network railway track measurement data.

7. The method of claim 1, wherein the geographical segment of track is located between one of two towns, two railroad switches, or two railroad stations.

8. The method of claim 1, wherein the second linear network railway track measurement data is offset from the first linear network railway track measurement data, wherein geographically aligning the first and second linear network railway track measurement data comprises:
applying an offset value to the second linear network railway track measurement data so as to shift the second linear network railway track measurement data to align with the first linear network railway track measurement data.

9. The method of claim 1, wherein the first and second linear network railway track measurement data are aligned without the use of an Absolute Position Based system or method or a Relative Position Based system or method.

10. The method of claim 1, further comprising:
receiving third linear network railway track measurement data collected during a third measurement campaign performed during a third time period, wherein the third linear network railway track measurement data includes third data corresponding to the shape and condition of the geographical segment of track during the third time period; and
geographically aligning the third linear network railway track measurement data collected during the third measurement campaign with the first aligned data using the third data corresponding to the shape and condition of the geographical segment of track collected in the third measurement campaign to thereby generate second aligned data.

11. The method of claim 1, wherein the first and second measurement campaigns collect the first and second railway track measurement data about every 25 centimeters.

12. The method of claim 1, wherein the first and second measurement campaigns collect the first and second railway track measurement data at intervals less than every three meters.

13. The method of claim 1, further comprising:
analyzing the first aligned data; and
based on the analysis, characterizing a progression of one or more track defects in the geographical segment of track.

14. A computing system comprising:
a processor;
a non-transitory computer readable storage medium having stored thereon computer readable instructions that, when executed by the processor, cause the computing system to perform a process of automatically aligning different rail track segment measurement campaigns, the computing system caused to:
receive linear network railway track measurement data associated with a plurality of measurement campaigns for a geographic segment of rail track; and
for each measurement campaign received:
identify a curvature of measurement points along the geographic segment of rail track;
determine a slope for the measurement points of a curve;
identify a beginning and an end of at least one curve located within the segment of track based upon a relative value of the slope compared to a threshold;
align the beginning of the at least one curve; and
align the end of the at least one curve.

15. The computing system of claim 14, the computing system further caused to:
generate aligned linear network railway track measurement data that includes the linear network railway track measurement data of the plurality of measurement campaigns for the segment of rail track that has had the beginning and the end of the least one curve aligned.

16. The computing system of claim 14, wherein the segment of rail track is located between one of two towns, two railroad switches, or two railroad stations.

17. The computing system of claim 14, where the linear network railway track measurement data includes one or more of track shape data, track profile data, track alignment data, curvature data, rail shape data, rail profile data, rail wear data, third rail data, or rail overhead wire data.

18. The computing system of claim 14, wherein the geographic segment of rail track includes a plurality of curves, computing system further caused to:
identify a beginning and an end of the plurality of curves located within the segment of track based upon a relative value of the slope compared to a threshold;
align the beginning of the plurality of curves; and
align the end of the plurality of curves.

19. The computing system of claim 14, the computing system further caused to:
apply an offset value to the linear network railway track measurement data of one of the plurality of measurement campaigns.

20. The computing system of claim 14, wherein the linear network railway track measurement data of one of the plurality of measurement campaigns includes less measurement points than the linear network railway track measurement data of at least one other of one of the plurality of measurement campaigns.

21. A method of aligning measurement data for a segment of railway track, comprising:
receiving a first set of linear network railway track measurement data relating to physical characteristics of the segment of railway track;
receiving a second set of linear network railway track measurement data relating to the physical characteristics of the segment of railway track; and
aligning the first set of linear network railway track measurement data with the second set of linear network railway track measurement data using the physical characteristics of the segment of railway track to align the physical characteristics to a track shape.

22. The method of aligning measurement data for a segment of railway track, of claim 21 further comprising the steps of:
receiving a third set of linear network railway track measurement data relating to the physical characteristics of the segment of railway track; and
aligning the third set of linear network railway track measurement data with the first and second sets of linear network railway track measurement data.
